(19) United States
(12) Patent Application Publication
(10) Pub. No.: US 2007/0172358 A1
(43) Pub. Date: Jul. 26, 2007

(54) Protection of surfaces against cavitation erosion

(75) Inventor: Knud Thomsen, Koblenz (CH)

Correspondence Address: SIEMENS SCHWEIZ AG;I-47, INTELLECTUAL PROPERTY, ALBISRIEDERSTRASSE 245, ZURICH, CH-8047, CH

(73) Assignee: Paul Scherrer Institut, Villigen (CH)

(21) Appl. No.: 10/587,506

(22) PCT Filed: Aug. 16, 2004
(86) PCT No.: PCT/EP04/09160

§ 371 Date: Jul. 27, 2006

Related U.S. Application Data
(60) Provisional application No. 60/542,292, filed on Feb. 9, 2004.

(51) Int. Cl. B64C 27/46

(52) U.S. Cl. 416/228

(57) ABSTRACT

Protection of a water solid interface from cavitation, pitting, or the like, is achieved by the introduction and maintaining of bubbles on and/or along the surface of the solid exposed to the liquid. To facilitate the maintaining, selectively placed protrusions and other deformations to the surface are introduced along with a bubble source.

The present invention relates to protection of surfaces in liquids and more particularly to protection of all kinds of hard surfaces subject to degradation due to cavitation erosion, pitting and the like. One special application of the invention refers to windows in Pulsed Spallation Targets. Other applications include ship components, such as parts of hulls, hydrofoils, propellers, rudders and other such surfaces wherein erosion protection or drag reduction is advantageous and desirable. Accordingly, the present invention is directed to protection of any surface in any type of liquid as set out in the precharacterizing portion of claim 1 and more particularly to a surface having a non-smooth portion as set out in the body of the claim. Additionally, the present invention is directed to a process for performing the protection as set out in claim 11. Other features and advantages of the present invention are discussed in the dependent claims.

It is a well known fact that most surfaces degrade due to cavitation erosion when subjected to a dynamic environment in a liquid. The dynamic conditions might be caused by rapid movement of a device inside a liquid or by the fast flow of the liquid or by pulsed energy deposition into the liquid.

Cavitation arises when the pressure at a point inside a liquid falls below the vapor pressure of the liquid at the given temperature. Usually, different periods in the progression of damage and erosion can be distinguished. Peculiarities like the presence and type of inhomogeneities and seeds in the liquid determine the details of the onset of cavitation. Cavitation severely impedes the functionality of the affected parts and limits their lifetime substantially. Several diverse modes of action for the detailed damage mechanism and the aggravation of erosion have been proposed.

Prior art solutions make use of strong materials, hard surface coatings and the admixture of gas to make the liquid softer, i.e. more compressible. In addition, shape optimisation is a common approach in order to somehow retard the onset and limit the occurrence of cavitation. In the case of hydrofoils, for example, another approach includes engulfing almost the complete structure inside a big gas (vapor) bubble, i.e. super-cavitating or super-ventilating designs, the main purpose of which is more focused on drag reduction. Other attempts to reduce the drag of moving objects, including complete ships use bubble ejection without concern to cavitation. Herein, the bubbles are released about certain ship surfaces and into the surrounding waters so as to reduce drag. One reason for such unconcern regarding cavitation is the very low relative velocities encountered by the effected vehicle surfaces.

Problems with the prior art solutions relate to the limited effectiveness of the known measures and the impossibility to meet all constraints, as for example for a propeller over an extended working range, simultaneously. Surfaces made from special materials or treated with the best available techniques and coatings still show vulnerability to attack by cavitation, albeit at longer operating times or higher load levels or repetition numbers. Added gas bubbles in the volume of the liquid follow its flow and trace the pressure distribution. They are seldomly concentrated in the optimum locations and thus are of limited value—namely use for the to-be-protected surface. Super-cavitating and super-ventilating devices can only be employed for a rather limited scope of tasks.

Devices with walls which are in need of protection against damage by cavitation erosion include tubes, pipes, ducts, manifolds, valves, vessels, pumps, combustion engines, reaction chambers, turbines, propellers, hydrofoils, and in particular, windows in spallation targets, especially in pulsed neutron sources. Different portions of the surface of a structure in contact with a liquid show different susceptibility to cavitation erosion also depending on many details including operational conditions.

It is a task of the present invention to protect almost any surface prone to cavitation attack by ensuring a sufficient density of gas bubbles of suitable composition and size residing right at the surface to be protected and its close vicinity. The amount of gas might be controlled accurately to yield a volume fraction of gas in the liquid in the relevant volume in the order of percent. In order to concentrate gas at an intended surface it is proposed to structure it in a suitable way to agglomerate, trap and retain gas bubbles there.

Accordingly, gas bubbles may catch in non-smoothed portions thereby holding fast to and remain at a desired location. With appropriate gas replenishment the current invention might also take the form of a basically smooth surface with gas venting or bleeding holes. Additionally, a combination of a strategically unsmooth surface with gas replenishment my form part of the present invention.

A certain fraction of the gas bubbles at a surface will be continuously lost into the adjacent liquid. Gas might be replenished to the surface out of the liquid with the surface structuring catching bubbles as they come along with the liquid flow. Another possibility would be to incorporate gas ducts in the bulk material underneath the surface to allow for a steady and controllable gas supply renewing lost bubbles.

Depending on the details of the requirements including the liquids and processes involved, materials, structures and carefully controlled supply of a suitable gas can be selected from a very wide variety. Special forms of discharge openings might be chosen to avoid crevice formation as seen in wormhole erosion. Gas distribution channels and ejection hole geometries might be employed similarly to the ones developed for use in gas bearings or cooling of fins in turbines at high temperatures. Specific design technicalities can be adapted and tailored to a very wide range of specific demands and applications. A process of laser-drilling might advantageously be combined with a laser-based surface treatment/hardening step like alloying.

The invention works for any hard surface material including metals, ceramics, and all kinds of diverse composites.

The invention works for any type of liquid including water, organic and inorganic solutions, hydrocarbons, any mixture and chemical solution, and liquid metals. For particular applications, any type of sufficiently non-condensable gas might be employed.

The present invention is directed to any surface in any type of liquid as set out in the precharacterizing portion of claim 1 and more particularly to a surface having a non-smooth portion as set out in the body of the claim. Other features and advantages of the present invention are discussed in the dependent claims.

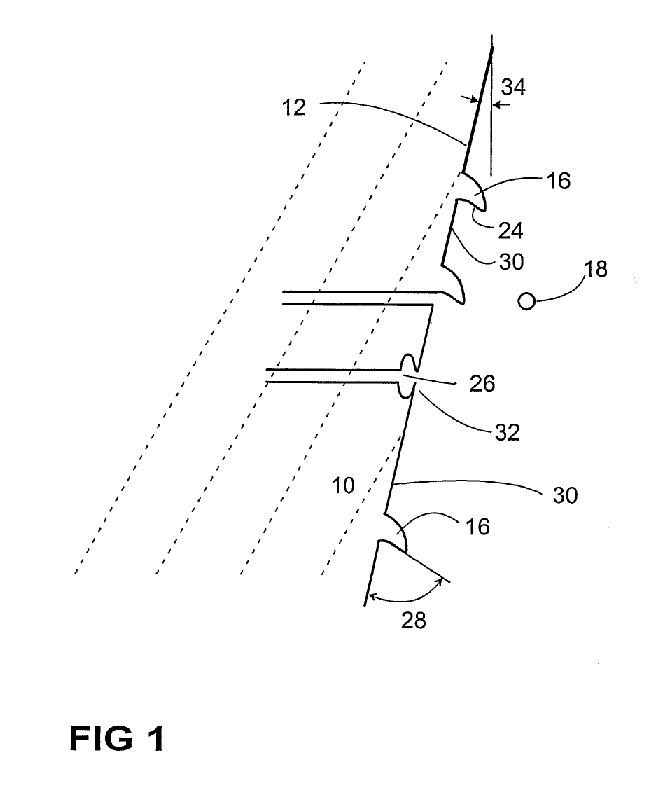

FIG. 1 presents a cross section of a surface including protrusions extending therefrom as well as means for gas replenishment.

The present invention is depicted in FIG. 1 which shows a cross section of a surface including a plurality of protrusions anchoring a plurality of bubbles to the surface and replenishment ducts with gas feeding from the rear side of the surface. The non-smooth portion may include extensions shaped and angled so as to catch and maintain or anchor bubbles in a preselected position according to the requirements and design details. Practical considerations for the protrusions and openings include the type of wall material, type of liquid, gas feed possibilities, total amount of materials needed and boundary conditions of operating states as e.g. temperatures and cooling requirements. The manufacture of the extensions or other surface structures discussed below may be combined with multilayer coatings of like or different material to the surface being worked. Likewise, special patterns including well specified single surface irregularities and also structures distributed in random may form part of the present inventive structure. Surface structure further depends upon design and application.

As depicted in FIG. 1, a wall 10 with a surface 12 is facing a liquid 14. The wall in total might be inclined from the vertical by an angle 34 so as to enhance the capturing of gas bubbles from the liquid. The surface is structured in a special way with some types of protrusions 16 arranged so as to catch gas bubbles 18 moving with the flow of the liquid or rising within the liquid due to their buoyancy. The recessions 20 of the surface thus defined by the protrusions 16 provide the preferred positions and holes for gas bubbles. In case active gas replenishment is incorporated, gas is fed through thin ducts 22 to the rear wall of such gas pockets 24. In addition or in place of the extensions, imperfections and irregularities in or on the wall 10 may be introduced. Such may cover all or part of the wall depending upon application. In another embodiment with gas replenishment the surface might be essentially flat with distributed gas bleeding holes 32. Gas bleeding holes 32 are openings from which gas escapes in a steady flow or in a controlled and regulated manner. According to the specific requirements of the exact locations, geometrical implementation, size and diameter of optimum bleeding holes might differ in detail. As applied to the present application, the escape of gas bubbles may be controlled by application by means known in the art.

The measures as proposed for protection against erosion due to cavitation might have very welcome beneficial side effects, including: gas bleeding out of the leading edge and surface patches of a propeller to tame cavitation and avoid pitting may at the same time improve efficiency by reducing drag. Active tuning of the amount of supplied gas might allow to optimally cover an extended range of operational conditions, e.g. for a ship propeller. Such may be accomplished by gas control and different measuring means like noise monitoring known to one skilled in the art. Novel efficient propeller designs might further be thus enabled by such active gas supply.

List of Elements

10 structure, solid/liquid interface
12 surface, liquid side
14 liquid
16 protrusion, extension, “lip”
18 gas bubble
20 recess
22 gas feeding duct
24 gas pocket
26 cavity
28 angle protrusion/general surface
30 smooth section
32 bleeding hole/outlet
34 angle of inclination against vertical

1. A solid/liquid interface comprising a liquid facing surfaces, wherein the surface comprises smooth and non-smooth structures, wherein the non-smooth structures are arranged to maintain gas bubbles proximate to the surface.

2. The interface according to claim 1, further comprising bubble source means arranged to produce bubbles proximate to the surface.

3. The interface according to claim 1, wherein the non-smooth structures comprise at least one protrusion arranged on the surface extending in a direction away from the surface.

4. The interface according to claim 3, wherein the at least one protrusion extends at an angle to the surface thereby cooperating with flat portions of the surface so as to define a recess arranged to maintain at least one bubble proximate to the surface.

5. The interface according to claim 2, wherein the bubble source means comprises at least one gas feeding duct arranged such that its outlet is proximate to the surface.

6. The interface according to claim 5, wherein the bubble source further comprises a cavity arranged between the feeding duct and the outlet at the surface so as to define a gas bleeding hole

7. The interface according to claim 1, wherein the surface comprises a hard material including at least one of a metal, ceramic and composite.

8. A window in a pulsed spallation neutron source comprising a solid/liquid interface having a liquid facing surface, wherein the surface comprises smooth and non-smooth structures, wherein the non-smooth structures are arranged to maintain gas bubbles proximate to the surface.

9. (canceled)

10. (canceled)

11. A process for preventing cavitation erosion to a surface exposed to liquid, comprising:
a. introducing a plurality of bubbles proximate to the surface; and
b. maintaining the bubbles on the surface.

12. The process according to claim 11, further comprising forming a non-smooth structure on the surface and arranging the non-smooth structure to capture the bubbles and maintain the bubbles on the surface.

13. The process according to claim 11, wherein forming a non-smooth structure further comprises forming a protrusion extending away from the surface and towards the liquid at an angle sufficient to form a cavity between the protrusion and surface of sufficient size so as to accommodate at least one bubble therein.

14. The process according to claim 11, wherein introducing a plurality of bubbles further comprises:
a. arranging a bubble source proximate to the surface; and
b. forming a bubble passage from the bubble source to the surface, the passage having an outlet at the surface for introducing the bubbles.

15. The process according to claim 14, wherein the outlet comprises a bleeding hole.

16. The process according to claim 11, wherein the surface comprises one of a metal, ceramic and composite.
